(19) United States
(12) Patent Application Publication
(10) Pub. No.: US 2016/0347043 A1
(43) Pub. Date: Dec. 1, 2016

(54) SIMULATED LEATHER COMPOSITION

(71) Applicants: Ralph Giammarco, New Berlin, WI (US); Michael Kolman, West Allis, WI (US)

(72) Inventors: Ralph Giammarco, New Berlin, WI (US); Michael Kolman, West Allis, WI (US)

(21) Appl. No.: 15/232,530

(22) Filed: Aug. 9, 2016

Related U.S. Application Data
(63) Continuation-in-part of application No. 14/960,142, filed on Dec. 4, 2015.
Application No. 14/960,142 is a continuation-in-part of application No. 13/326,080, filed on Dec. 14, 2011, now abandoned.
(60) Provisional application No. 61/528,502, filed on Aug. 29, 2011.

(51) Int. Cl. B32B 37/00; B41M 5/50; B44C 1/16; B32B 5/16

(52) U.S. Cl. CPC B32B 37/025; B32B 5/16; B41M 5/50; B44C 1/16; B32B 2451/00; B32B 2255/04; B32B 2264/105

(57) ABSTRACT

The present invention is a multi-layered simulated leather composition with a realistic surface appearance. The first layer is a deformable fiber surface layer having a unique uniform random pattern. The second and third membrane and fixative layers conform to the unique uniform random pattern, allowing the unique uniform random pattern to be visible through the membrane. The membrane may be printed on both sides to provide a realistic simulation of leather and allow a user to print a graphic on the simulated leather.

### CROSS-REFERENCE TO RELATED APPLICATIONS

This patent application is a continuation-in-part of U.S. patent application Ser. No. 14/960,142, titled “Nanometallic Transportable Graphic System,” filed on Dec. 4, 2015, which is a continuation-in-part of U.S. patent application Ser. No. 13/326,080, titled “Nanometallic Transportable Graphic System,” filed on Dec. 14, 2011, which claims the benefit of priority to U.S. Provisional Application No. 61/528,502, titled “Transportable Graphic and System,” filed on Aug. 29, 2011. All of the above applications are hereby incorporated by reference in their entirety.

### FIELD OF INVENTION

This invention relates to the field of manufacture using adhesive bonding and more specifically to a simulated leather composition manufactured by adhesive bonding.

### BACKGROUND OF THE INVENTION

“Faux” leather is one of several names given to artificial or synthetic leather. These names are often used to describe specific end uses of synthetic leather products such as faux leather (sofa, chair and headboard upholstery), leatherette (auto upholstery, clothing), and koskin (consumer goods).

Synthetic leather has been popular since the 1940's, initially for products such as shoes, automobile interiors and upholstery. In the late 1950's DuPont and other chemical companies began developing polyurethane products. There are two primary types of faux leather construction: polyurethane (“PU”), and polyvinyl chloride (PVC—“Vinyl”). Both polyurethane and vinyl synthetic leathers are used in making clothing, upholstery, and product covers, but both have different characteristics.

Vinyl upholstery is made from two separate synthetic materials. The fibers of the upholstery are constructed from strong polyester fibers. The fibers are then coated with vinyl, made from polyvinyl chloride (PVC) and plasticizers (phthalic acid). This vinyl is melted onto the surface of the fibers, sealing them closed and making a virtually waterproof surface that is still flexible and tough.

PU is made by coating a backing fabric such as cotton, polyester or shredded leather with a flexible polymer and then treating it to look more like animal hide. Polyurethane upholstery is the most realistic imitation of genuine leather, with respect to hand, surface feel, and overall appearance. When stitched, gathered, or tufted it actually “breaks” or wrinkles like real leather. Because there are no plasticizers used in PU upholstery there is no cracking or peeling, and it remains supple. Polyurethane is considered preferable to vinyl because it does not create dioxins and does not need additional plasticizers. Polyurethane costs less than real leather but it is more expensive to produce than vinyl.

A problem known in the art is that synthetic leather can be visually distinguished from real leather. Real leather has inconsistently spaced surface lines forming the characteristic leather pattern while fake leather will have a perfectly even or repeating pattern.

Another problem is that the surface appearance of synthetic leather is not easily customized for small projects or lots, or with artistic renditions and images.

There is an unmet need in the art for easily customizable synthetic leather having a realistic appearance.

### BRIEF SUMMARY OF THE INVENTION

The present invention is a multi-layered simulated leather composition with a realistic surface appearance. The first layer is a deformable fiber surface layer having a unique uniform random pattern. The second and third membrane and fixative layers conform to the unique uniform random pattern, allowing the unique uniform random pattern to be visible through the membrane. The membrane may be printed on both sides to provide a realistic simulation of leather and allow a user to print a graphic on the simulated leather.

### BRIEF DESCRIPTION OF SEVERAL VIEWS OF THE DRAWING(S)

FIG. 1 illustrates a cross-sectional view of an exemplary embodiment of a simulated leather composition.

FIG. 2 illustrates a flowchart of an exemplary embodiment of a method of making a simulated leather composition

### TERMS OF ART

As used herein, the term “affixed” refers to one or more elements placed in position by placement of a structure, component or compound

As used herein, the term “electromagnetic target surface” refers to any surface, regardless of materials, contours and porosity, which is sufficiently free from solid particulate matter (e.g., impurities and dust) and liquids to allow the formation of a nano-ionic bond.

As used herein, the term “fixative” refers to a material capable of attaching itself to another material.

As used herein, the term “geometrically conform” refers to modifying an element's shape or configuration to make it substantially similar to the shape or configuration of another element.

As used herein, the term “metallically infused” refers to having a composition in which one or more metallic particles are dispersed or suspended. Metallic particles include, but are not limited to, copper, silver, platinum, zinc, zirconium, gold, iridium, metal alloys, and combinations of these metallic particles and other alloys.

As used herein, the term “metallically infused target surface adhesion layer (TSAL)” refers to a layer constructed from polymer and infused with metallic particles. A metallically infused TSAL bonds inks or toners and a target surface.

As used herein, the term “metallically infused protection layer” refers to a layer constructed from polymer and infused with metallic particles. A metallically infused protection layer protects a metallically infused target surface adhesion layer and any bound inks from mechanical, chemical and environmental degradation.

As used herein, the term “nano-ionic bonding force field” refers to ionic bond created by the presence of nanometallic particles in one surface that bond to a target surface without the use of adhesive. A nano-ionic bond force field creates a physical bond between the surfaces.

As used herein, the term “parts per hundred” refers to the number of parts of an additive added to a base composition per one hundred parts of the base composition. For example, an additive added at 40 parts per hundred would have 20 parts added to a base composition having 50 parts.

As used herein, the term “printable membrane” refers to a pliable sheet of a substance capable of receiving printed graphics or indicia.

As used herein, the term “softening point” refers to the temperature at which a specimen of a material is penetrated to a depth of 1 mm by a flat-ended needle with a 1 mm² circular or square cross-section.

As used herein, the term “spunbound fiber” refers to fabrics produced by depositing extruded, spun filaments in a uniform random manner, followed by bonding the fibers.

As used herein, the term “texture” or “surface texture” refers to any tactile or visual quality.

As used herein, the term “unique uniform random pattern” refers to a pattern of uniform elements (e.g. fibers) having a random directional orientation within a plane or sample.

### DETAILED DESCRIPTION OF THE INVENTION

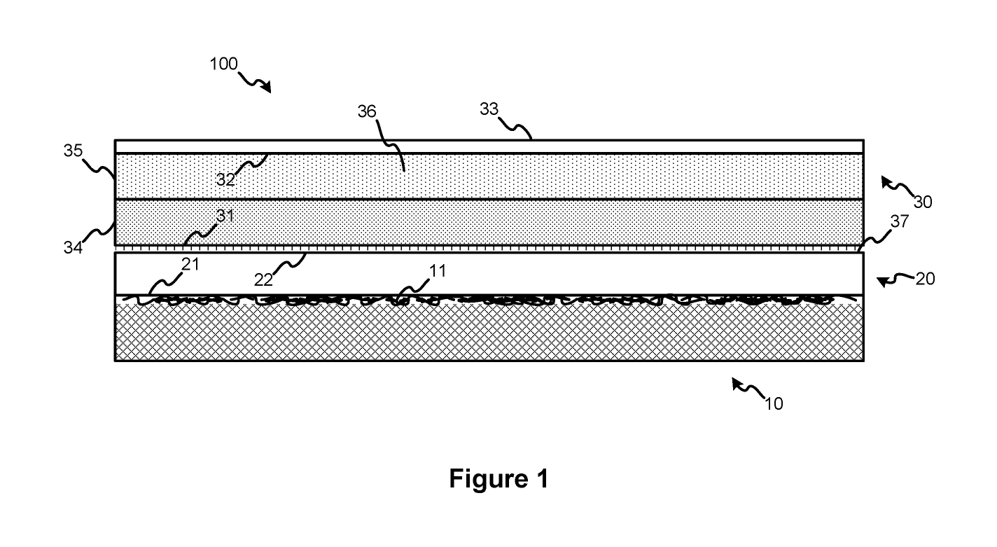

FIG. 1 illustrates a cross-sectional view of an exemplary embodiment of simulated leather composition 100. Simulated leather composition 100 includes a deformable fiber surface layer 10 having a unique uniform random pattern 11 which creates a unique uniform random pattern 11. A fixative layer 20 atop deformable fiber surface layer 10 conforms to unique uniform random pattern 11. A printable membrane layer 30 atop fixative layer 20 also conforms to unique uniform random pattern 11.

In the exemplary embodiment, deformable fiber surface layer 10 is a spunbound fiber. In certain embodiments, deformable fiber surface layer 10 is heat-bound spun polymer fibers, such as, but not limited to, Eco-Fi®. Unique uniform random pattern 11 is created by the affixation of randomly placed moveable fibers.

In the exemplary embodiment, fixative layer 20 is a pressure sensitive adhesive composition. In one embodiment, fixative layer 20 is an adhesive composition such as, but not limited to, a carboxylated styrene butadiene polymer, a stabilized natural rubber latex emulsion, or any combination thereof. In the exemplary embodiment, the carboxylated styrene butadiene polymer has a styrene-to-butadiene ratio of 25:75. In certain embodiments, the adhesive composition making up fixative layer 20 may also include additives such as, but not limited to, a tackifying resin, an antioxidant, an ultraviolet (UV) stabilizer, or any combination thereof.

The tackifying resin may be added to the composition at approximately 40 parts per hundred to approximately 140 parts per hundred. The antioxidant may be added to the composition at up to approximately 0.5 parts per hundred. The UV stabilizer may be added to the composition at up to approximately 0.5 parts per hundred. The tackifying resin may be a rosin ester tackifying resin with a softening point of approximately 20 degrees C. to approximately 80 degrees C. or an aliphatic tackifying resin with a softening point of approximately 20 degrees C. to approximately 140 degrees C.

Fixative layer 20 has a lower fixative surface 21 and an upper fixative surface 22. A fixative transfer backing may initially cover upper fixative surface 22 to allow transfer of fixative layer 20 to deformable fiber surface layer 10. Once lower fixative surface 21 is bonded to unique uniform random pattern 11, the fixative transfer backing may be removed to allow upper fixative surface 22 to bond to printable membrane layer 30.

Printable membrane layer 30 has a lower membrane surface 31 and an upper membrane surface 32. Lower membrane surface 31 may have a lower printed pattern which can mimic leather or imitate any other desired material. Upper membrane surface 32 may have an upper printed pattern which may provide additional definition to the lower printed pattern or present a different image. In certain embodiments, upper membrane surface 32 also has a coating 33 of a protective substance, such as, but not limited to, a polymer.

In the exemplary embodiment, printable membrane layer 30 is a nanometallic transportable graphic apparatus with at least one printable, metallically infused target surface adhesion layer (TSAL) 34 integrally bound to at least one metallically infused protection layer 35 and a variable, user-selected electromagnetic target surface. In certain embodiments, printable membrane layer 30 may lack protection layer 35. In the exemplary embodiment, the electromagnetic target surface is fixative layer 20. TSAL 34 has a non-porous outer surface to which ink may be applied in a printing process. Both TSAL 34 and metallically infused protection layer 35 are infused with nanometallic particles 36 smaller than 100 nm. Nanometallic particles 36 of TSAL 34 create a nano-ionic bonding force field 37 between TSAL 34 and the target surface.

In the exemplary embodiment, nanometallic particles 36 are selected from the group consisting of copper, silver, platinum, zinc, zirconium, gold, iridium, metal alloys and combinations thereof. In the exemplary embodiment, nanometallic particles 36 have a size in the range of approximately 25 nm to approximately 65 nm. The concentration of nanometallic particles 36 in each of metallically infused TSAL 34 and metallically infused protection layer 35 is between 1 ppm and 100 ppm.

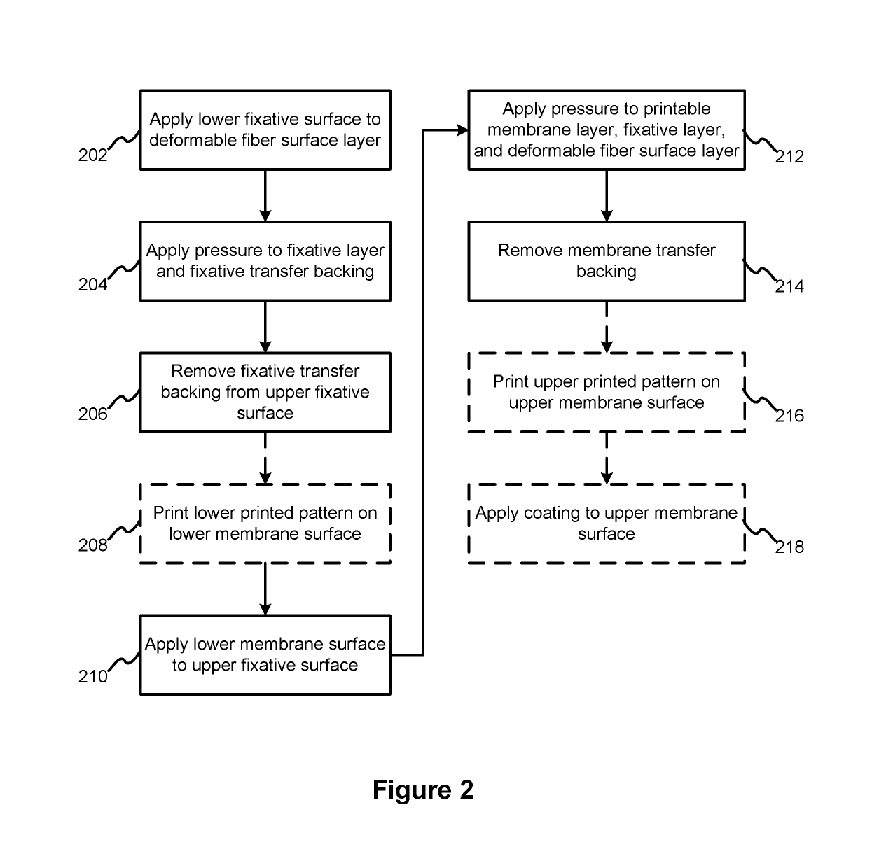

FIG. 2 illustrates a flowchart of an exemplary embodiment of method 200 of making simulated leather composition.

In step 202, method 200 applies lower fixative surface 21 of fixative layer 20 to deformable fiber surface layer 10 such that fixative layer 20 conforms to unique uniform random pattern. During this step, a fixative transfer backing covers upper fixative surface 22 of fixative layer 20.

In step 204, method 200 applies pressure to fixative layer 20 and the fixative transfer backing.

In step 206, method 200 removes the fixative transfer backing from upper fixative surface 22.

In optional step 208, method 200 prints a lower printed pattern on lower membrane surface 31 of printable membrane layer 30. This lower printed pattern can mimic leather or imitate any other desired material.

In step 210, method 200 applies lower membrane surface 31 to upper fixative surface 22. During step 210 (and step 208, if implemented), a membrane transfer backing covers upper membrane surface 32. In certain embodiments, this membrane transfer backing may be a carrier infused with nanometallic particles.

In step 212, method 200 applies pressure to printable membrane layer 30, fixative layer 20, and deformable fiber surface layer 10.

In step 214, method 200 removes the membrane transfer backing.

In optional step 216, method 200 prints an upper printed pattern on upper membrane surface 32.

In optional step 218, method 200 applies a coating to upper membrane surface 32.

It will be understood that many additional changes in the details, materials, procedures and arrangement of parts, which have been herein described and illustrated to explain the nature of the invention, may be made by those skilled in the art within the principle and scope of the invention as expressed in the appended claims. Moreover, the terms “about,” “substantially” or “approximately” as used herein may be applied to modify any quantitative representation that could permissibly vary without resulting in a change in the basic function to which it is related.

It should be further understood that the drawings are not necessarily to scale; instead, emphasis has been placed upon illustrating the principles of the invention.

What is claimed is:

1. A simulated leather composition comprised of:
a deformable fiber surface layer having a unique uniform random pattern;
a printable membrane layer which geometrically conforms to said unique uniform random pattern; and
a fixative layer which geometrically conforms to said unique uniform random pattern.

2. The composition of claim 1, wherein deformable fiber surface layer is comprised of spunbound fiber.

3. The composition of claim 1, wherein said deformable fiber surface layer is comprised of heat-bound spun polymer fibers.

4. The composition of claim 1, wherein said unique uniform random pattern is created through the affixation of randomly placed moveable fibers.

5. The composition of claim 1, wherein said printable membrane layer comprises a nanometallic transportable graphic apparatus comprised of at least one printable, metallically infused target surface adhesion layer (TSAL) having a non-porous outer surface to which ink may be applied in a printing process;

6. The composition of claim 5, wherein said metallically infused TSAL is infused with nanometallic particles,

7. The composition of claim 6, wherein said nanometallic particles of said metallically infused TSAL create a first nano-ionic bonding force field between said metallically infused TSAL and a target surface.

8. The composition of claim 6, wherein said nanometallic particles are selected from the group consisting of copper, silver, platinum, zinc, zirconium, gold, iridium, metal alloys and combinations thereof.

9. The composition of claim 6, wherein said nanometallic particles have a size in the range of 25 nm to 65 nm.

10. The composition of claim 6, wherein the concentration of said nanometallic particles in said metallically infused TSAL is between 1 ppm and 100 ppm.

11. The composition of claim 5, wherein said TSAL is integrally bound to at least one metallically infused protection layer infused with nanometallic particles.

12. The composition of claim 1, wherein said printable membrane layer has a lower membrane surface with a lower printed pattern.

13. The composition of claim 1, wherein said printable membrane layer has an upper membrane surface with an upper printed pattern.

14. The composition of claim 13, wherein said upper membrane surface has a protective polymer coating.

15. The composition of claim 1, wherein said fixative layer is an adhesive composition selected from the group consisting of: carboxylated styrene butadiene polymer, a stabilized natural rubber latex emulsion, or any combination of the two.

16. The composition of claim 15, wherein said carboxylated styrene butadiene polymer has a styrene-to-butadiene ratio of 25:75.

17. The composition of claim 15, wherein said fixative layer further includes at least one additive selected from the group consisting of: a tackifying resin, an antioxidant, and a UV stabilizer.

18. The composition of claim 17, wherein said tackifying resin selected from the group consisting of: a rosin ester tackifying resin with a softening point of approximately 20 degrees C. to approximately 80 degrees C. and an aliphatic tackifying resin with a softening point of approximately 20 degrees C. to approximately 140 degrees C.

19. A method of assembling a simulated leather composition, comprising the steps of:
applying a lower fixative surface of a fixative layer to a deformable fiber surface layer having a unique uniform random pattern such that said fixative layer conforms to said unique uniform random pattern,
wherein an upper fixative surface of said fixative layer is covered by a fixative transfer backing;
applying pressure to said fixative layer and said fixative transfer backing;
removing said fixative transfer backing;
applying a lower membrane surface of a printable membrane layer to said upper fixative surface,
wherein an upper membrane surface of said printable membrane layer is covered by a membrane transfer backing;
applying pressure to said printable membrane layer, said fixative layer, and said deformable fiber surface layer; and
removing said membrane transfer backing.

20. The method of claim 19, further comprising the step of printing a lower printed pattern on said lower membrane surface before applying said lower membrane surface to said upper fixative surface.

21. The method of claim 19, further comprising the step of printing an upper printed pattern on said upper membrane surface after removing said membrane transfer backing.
